(19) United States
(12) Patent Application Publication
(10) Pub. No.: US 2008/0046923 A1
(43) Pub. Date: Feb. 21, 2008

(54) System for automatic advertisement targeting by means of traffic analysis

(76) Inventor: Thomas Jeffrey Enderwick, San Francisco, CA (US)

Correspondence Address: Thomas Jeffrey Enderwick, 426 29th Street, San Francisco, CA, 94131, US

(21) Appl. No.: 11/894,370

(22) Filed: Aug. 20, 2007

Related U.S. Application Data
(60) Provisional application No. 60/838,946, filed on Aug. 21, 2006.

(51) Int. Cl. H04N 7/10

(52) U.S. Cl. 725/35

(57) ABSTRACT

The invention-consists of a system that examines consumer data in the form of subscriber traffic, populates databases, and targets advertising to consumers based on those databases. For example, an Internet service provider, cable television provider, wireless service provider, or other party who has access to consumers' Internet data traffic, voice traffic, or video traffic could use the invention. In such a case, the user of the invention would be able to market targeted advertisements, advertisement targeting services, or subscriber information. The targeted advertisements could be delivered over the same data network, a different data network, or even a completely different media, including but not limited to: television, pay-per-view video or print.

### CROSS-REFERENCE TO RELATED APPLICATIONS

This application claims the benefit of provisional patent application Ser. No. 60/838,946, filed 2006 Aug. 21 by the present inventor.

### FEDERALLY SPONSORED RESEARCH

Not applicable.

### SEQUENCE LISTING OR PROGRAM

Not applicable.

### BACKGROUND OF THE INVENTION

### Field Of The Invention

This invention relates to the targeting and delivery of advertising based on individual consumer behavior, using the observation of consumer network traffic data to create or augment the targeting of advertising. This invention also detects and defeats some forms of click-fraud. Networks carry consumer information, including but not limited to: world-wide web traffic, the downloading or streaming of products, video, audio, network-based conversations including multi-way interaction using text, data, voice and/or video. It is often the case that a consumer is also a subscriber of a network service or network access provider.

### BACKGROUND

### Discussion Of Prior Art

When advertising to consumers, an advertisement is more likely to be effective if the advertisement is displayed or played to a consumer who has expressed a prior interest in or need for the advertised product or service. When there is an opportunity to place an advertisement before a consumer, it is more profitable to display or play an advertisement that is more likely to be acted upon. Correspondingly, if a business whishes to advertise a product or service, then it is more economical to only pay to advertise to those consumers who are likely purchasers. The selecting of likely consumers is the act of targeting advertising. The targeting of advertising is based on knowledge of the consumer or inferences made based on the consumer's behavior.

Click-fraud includes unnatural consumer behavior relative to paid advertisement where such behavior causes financial damage to an advertiser or a publisher of advertisements. Click-fraud also includes the simulation of consumer behavior by an automated mechanism for the purpose of inflicting financial damage on an advertiser or a publisher of advertisements. In the case where an advertiser is charged for each consumer response rather than or in addition to being charged for the placement of an advertisement, a large number of false or simulated consumer responses causes the advertiser to be charged more, with no potential benefit to the advertiser.

The targeting of advertising has been based on information gathered in ways other than the observation of consumer network traffic (data traveling on the network), such as: the manual collection of information about each consumer or group of consumers, the collection of information about each consumer or group of consumers through other external data processing systems, data mining, the tracking of television channel selections by consumers, the tracking of personal video recorder behavior as directed by consumers, the use of browser cookies as a mechanism for tracking consumer Internet browsing behavior, the use of computer spy-ware to monitor consumer computing behavior, and by the recoding of on-web-site user behavior. These information-gathering methods all share one or more of the following limitations.

They fail to capture the entirety of the targeting information flowing across the network. Cookie tracking is limited to one or a confederation of web sites, as server access to web browser cookies is limited by the domain name of the web server. when using cookies to track user behavior, one cannot track user behavior at unaffiliated sites, nor can one track targeting information embedded in non-HTTP applications. These methods are restricted to HTTP-based systems, and cannot be applied to voice networks, email or instant messaging, for example.

They fail to produce targeting information that is relevant to a consumer's immediate indications; the opportunity to advertise for a particular purchasing decision can be far gone by the time a targeted advertisement is put before the consumer. Data mining of prior consumer behavior is not able to capture current pre-purchase behavior, e.g. a consumer researching new televisions on the Internet, planning to buy that television later in the day.

They require the consumer's computer to be open to cookies or to allow on-system monitoring (spy-ware). The use of cookies and/or spy-ware can be completely inhibited if the consumer detects and blocks spy-ware or if the consumer's Internet browser is configured to block cookies.

They are inapplicable for direct implementation by network service providers. For an entity in the business of providing network access or transit, the aforementioned techniques cannot be applied in most instances. Where consumers are subscribers of network service or network access providers, subscriber traffic is consumer data, and as such is a rich source of consumer targeting information that is currently unavailable to network providers for monetization.

### SUMMARY

The invention consists of a system that examines consumer data in the form of subscriber traffic, populates databases, and targets advertising to consumers based on those databases. For example, an Internet service provider, cable television provider, wireless service provider, or other party who has access to consumers' Internet data traffic, voice traffic, or video traffic could use the invention. In such a case, the user of the invention would be able to market targeted advertisements, advertisement targeting services, or subscriber information. The targeted advertisements could be delivered over the same data network, a different data network, or even a completely different media, including but not limited to: television, pay-per-view video or print.

The invention may be implemented using off-the-shelf computer equipment, or maybe be implemented within custom or standard networking equipment, or some combination thereof. Cost, scope and scale are three factors that influence the choice of equipment used to implement the system.

### DESCRIPTION OF THE DRAWINGS

### Figures

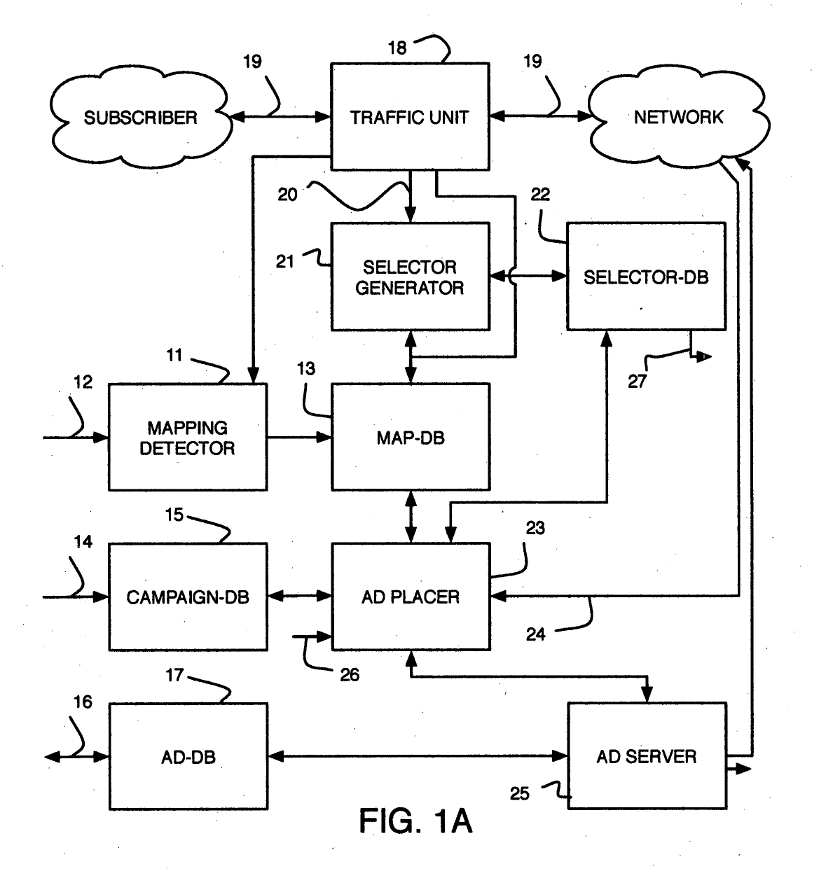

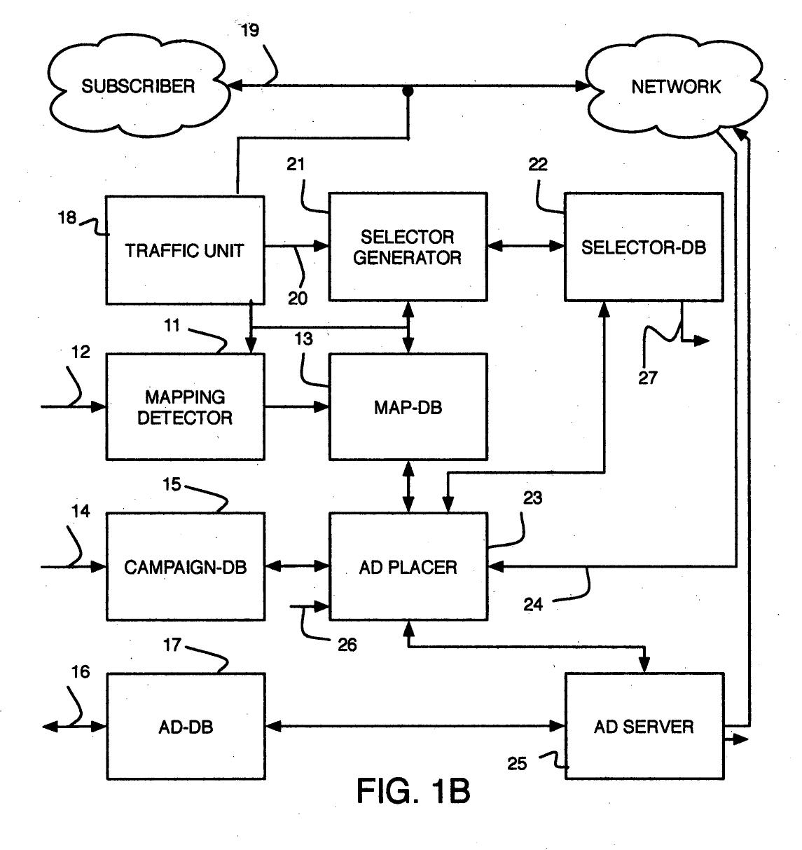

FIGS. 1A and 1B show the functional blocks and connections required to implement the preferred embodiment of the invention. FIG. 1A shows an in-line configuration of the invention, while FIG. 1B shows the invention in a tap configuration. In the latter configuration, the invention is not able to alter the traffic flowing in-between the network and the subscribers.

### DESCRIPTION OF THE DRAWINGS

### Reference Numerals

11 mapping detector
12 network protocol traffic related to the binding and unbinding of subscribers to subscriber addresses
13 map database
14 advertising campaign queries and updates
15 campaign database
16 advertisement updates
17 ad database
18 traffic unit
19 traffic between subscriber and network, also referred to as “consumer data on the network”.
20 relevant segments of traffic between subscriber(s) and the network, or data that includes a representation of relevant segments of traffic between subscriber(s) and the network.
21 selector generator
22 selector database
23 ad placer
24 requests for ad placement coming from the network
25 ad server
26 request for ad placement coming from outside the network
27 export of selector database information

### DETAILED DESCRIPTION

### FIGS. 1A and 1B

The term subscriber address is used generically to indicate any mechanism that can be used to discriminate which subscriber is participating in a given traffic flow. For example, IP address, or IP address combined with TCP port might constitute a subscriber address in some environments. In another environment, an Ethernet VLAN tag might constitute a subscriber address. In another example, the context of traffic reception from a physical interface or tunnel interface may be a factor in the subscriber address. A subscriber address may be a network address. The types of subscriber addresses are not limited the foregoing examples.

The mapping detector 11 scans protocol traffic related to the binding of subscriber addresses to subscribers 12. From this scanned traffic it maintains the map database 13, which holds pairings between subscribers and subscriber addresses. In some cases, the map database 13 may be populated with static subscriber address data, or programmed in some manner other than binding traffic analysis. The map database 13 may also hold unique identifiers as instructed by the ad placer 23.

The campaign database 15 holds various advertising campaigns, including information or algorithms that stipulate the criteria under which an ad is considered authorized to run, possibly including price and subscriber selection criteria. Campaigns 14 are added and removed from the campaign database 15. The campaign database 15 also contains status on campaign implementation progress, which may be externally queried.

The ad database 17 holds actual advertising assets associated with campaigns in the campaign database 15.

The traffic unit 18 either sits in-line between the subscriber(s) and the network as seen in FIG. 1A, or on a tap as shown in FIG. 1B. In either case, the traffic unit 18 observes traffic between the subscriber(s) and the network 19, forwarding relevant sections of traffic 20 to the selector generator 21. The determination of relevance takes place within the traffic unit 18. Relevance is dependent on the advertising application of the invention, as determined by the classes of advertising campaigns being serviced by the invention.

If the traffic unit 18 is deployed in-line as in FIG. 1A, then it is capable of injecting or altering messages in either the direction of the network or the direction of the subscriber for the purpose of facilitating subscriber determination by the ad placer 23.

Whether the traffic unit 18 is deployed either in-line as in FIG. 1A or on a tap as in FIG. 1B, it is able to detect any in-band identifier created by the ad-placer 23, and pass it to the mapping detector 11 for insertion into the map database 13.

The traffic unit 18 may also implement tracking mechanisms for the prevention of click-fraud. Such a mechanism maintains per-subscriber state, using an algorithm to detect subscribers that are generating an inordinate number of ad clicks, or a repetitive and targeted stream of ad clicks. This mechanism can be configured to block or limit offending subscriber access to the network, assuming that the configuration in FIG. 1A is employed.

The selector generator 21 maintains the selector database 22. It processes relevant traffic from the traffic unit 18 in order to maintain the selector database 22.

The selector database 22 contains the compiled per-subscriber information. It may also carry per-subscriber information related to the detection of click-fraud. The selector database, or access to it, may be exported as a product of the invention 27.

The ad placer 23 receives requests for ad placement 24, accesses the selector database 22, the campaign database 15 and possibly the map database 13, and determines ad placement. The ad placer 23 may also implement tracking mechanisms for the prevention of click-fraud.

The ad server 25 retrieves advertising assets and places them as indicated by the ad placer 23. The ad may be placed via the network, or it may be placed via another media altogether.

### DETAILED DESCRIPTION

### Operation

The mapping detector 11 observes network protocol traffic related to the binding and unbinding of subscribers to subscriber addresses 12. The mapping detector uses information contained in this traffic to maintain a map database 13. Protocol traffic includes but is not limited to DHCP/BOOTP, RADIUS, PPP, and various forms of user login. For example, the protocol can be a proprietary method of publishing data related to the binding and unbinding of subscribers to subscriber addresses. In such a case, the protocol may be between the mapping detector and an external server, and in such a case may not directly include the subscriber.

Advertising campaigns 14 are entered into and removed from the campaign database 15. Corresponding advertising assets 16 are entered into and removed from the ad database 17. An advertising campaign includes information or algorithms stipulating the criteria under which one or more advertisers will desire that one or more advertisements to be displayed, played, or otherwise rendered to a consumer. The algorithms may display dynamic output based on a plurality of input, including but not limited to: per-user criteria, the dynamic state of the advertising campaign, and cost. Advertising assets include but are not limited to: text advertisements, pictorial advertisements, video advertisements, audio advertisements, and combinations thereof. Linkage is maintained between entries in the campaign database 15 and entries in the ad database 17.

The traffic unit 18 observes traffic between the subscriber and the network 19 flowing through the traffic unit as seen in FIG. 1A, or it observers the traffic via a tap connection as seen in FIG. 1B. The traffic unit 18 forwards sections of traffic deemed relevant 20 to the selector generator 21. The traffic unit 18 or the selector generator 21 may access the map database 13 in the process of handling this relevant traffic. The selector generator uses this relevant traffic to build and maintain the selector database 22. The traffic unit 18 is able to handle the entirety of transiting network traffic 19, and if configured as seen in FIG. 1A, the traffic unit 18 does not reduce the amount of transiting network traffic 19. Depending on the expected quantity of network traffic 19 and the supported network traffic 19 types, the traffic unit 18 may be implemented by but not limited to using the following technologies: custom electronic hardware, digital signal processors, application-specific integrated circuits, general purpose microprocessors, including pluralities and combinations of the aforementioned. The traffic unit 18 is programmable so that new pattern matching structures may be introduced as new network traffic 19 analysis requirements are encountered, The relevant segments 20 are a fraction of the bandwidth of the network traffic 19 encountered by the traffic unit 18. The selector generator 21 is also programmable such that the behavior of the selector generator 21 may be modified in the future. An operational example is the traffic unit 18 extracting the string “http://www.bmwusa.com”, associating the string with a subscriber from the map database 13, and passing the combination to the selector generator 21 as a relevant section 20. The selector generator 21 then updates the selector database 22 with information that the subscriber is a consumer expressing interest in BMW automobiles. The aforementioned operational example is not intended to limit in any way the operational capabilities of the system to the operations contained in the example.

A request for ad placement is generated and delivered to the ad placer 23. If the request is generated by network traffic 19 between the subscriber and the network 24, the traffic unit 18 may inject an indication as to subscriber identity directly into this network traffic 19 as it flows toward the network, eventually reaching the ad placer 23. Additionally, the traffic unit 18 may choose to send a message to the subscriber so that the subscriber generates this indication in future cases without the per-request involvement of the traffic unit 18. An operational example of a request generated by network traffic 19 between the subscriber and the network 24 might be a URL accessed by the subscriber, where the domain name points to the ad placer 23. An operational example of the traffic unit 18 injecting an indication as to subscriber identity directly into this network traffic 19 as it flows toward the network might be adding a GET argument to a HTTP URL access where the domain name within the URL points to the ad placer 23. An operational example of the traffic unit 18 sending a message to the subscriber so that the subscriber auto-indicates going forward might be: the traffic unit directly injecting a HTTP cookie for the domain of the ad placer 23, without the involvement of the ad placer or any other server. These operational examples do not limit the capabilities of the system.

It may be the case that the ad placer 23 can resolve the specific subscriber from only the subscriber address or network address of the request. In such cases, the ad placer uses the map database 13 to resolve the specific subscriber, rather than relying on an in-band indication. In such cases, the need for the ad traffic unit 18 to remain in-line may be obviated and the configuration in FIG. 1B will function properly.

Alternatively, if the ad insertion protocol allows, the ad placer 23 may signal a unique identifier in-band before selecting the ad to be placed. The traffic unit 18 then detects this unique identifier in network traffic 19 headed toward the subscriber, and either the traffic unit 18 passes the identifier to the mapping detector 11 so that the mapping detector 11 can bind the identifier to the subscriber in the map database 13 such that the ad placer 23 can recover the subscriber identity, or the traffic unit 18 may signal the subscriber indication in-band as an alternative. An operational example would be a case where the ad placer is to send an advertising message to a subscriber, and there is the ability to send only the preamble of the message, and there is the ability of the ad placer 23 to inject a unique token into the preamble without significantly degrading the quality of the message. The traffic unit 18 would detect the token. After which, the traffic unit 18 could either send the subscriber identity to the ad placer 23 through the network traffic 19, or use the mechanism employing the map database 13 as described above. This operational example is not intended to limit the capabilities of the system; it is included only as one example of the system in operation.

If the request is not generated by traffic within the network 26, then an indication of the subscriber must be recovered from the request for ad placement.

The ad placer 23 receives requests for ad to be placed 24 and acts, as described above, to be sure that the request is associated with a subscriber or group of subscribers. The ad placer then accesses the campaign database 15 and the selector database 22, picking the most appropriate advertisement(s) to fill the placement opportunity. The ad placer 23 then commands the ad server 25 to place the selected ad using the network. The ad placer 23 is programmable, and can be upgraded over time.

The ad server 25 retrieves the referenced ad asset or assets from the ad database 17. The ad server 25 indicated the status of the ad placement to the ad placer 23, which then updates the campaign database 15. The actual ad placement may take place through the network, or possibly through some other channel altogether. An example of ad placement using the network might be an Internet banner ad. And example of an ad placement outside the network might be a printed mailer delivered via the postal system.

The invention's affectivity could be compromised if subscribers were to adopt an overlaying data transport mechanism that obscures the bulk of the subscriber's data. Examples would be SSL, or VPNs using IPsec, or some other form of tunneling that makes it impossible for the traffic unit 18 to select relevant segments of traffic between subscriber and network 20. Downstream competitors within the network could offer such obfuscation mechanisms as a way to shift the advantage away from the user of the invention.

Techniques could be used to mitigate the use of traffic obfuscation. The traffic unit 18 could be augmented to detect subscribers that are using obfuscation. This information would then be passed to the selector generator 21, and stored in the selector database 22. When the ad placer 23 is requested to place an advertisement for a subscriber using obfuscation, the ad placer 23 can choose less desirable advertisements, or advertisements extolling the benefits of ceasing to employ obfuscation. Using these techniques, the invention is able to provide a better experience for subscribers who choose not to obfuscate. Subscriber obfuscation information could also be exported for differential customer billing.

The traffic unit 18 could be augmented to block certain types of obfuscated traffic, or to block obfuscated traffic to specific network addresses, particularly those of downstream competitors. The traffic unit 18 could also be augmented to affect a better quality of service for subscribers who have chosen not to obfuscate their traffic. In order to block traffic or influence quality of service, the traffic unit 18 must be configured in-line, as seen in FIG. 1A.

The invention need not be deployed at the edge of the network closest to the subscriber. The invention may be deployed anywhere in the network where the traffic unit 18 will be able to discern which traffic belongs to which subscriber. This could be, for example, behind a VPN device in the middle of the network.

What is claimed:

1. A method of deriving advertisement targeting data, comprising:
(a) examining consumer data on the network, and
(b) correlating a portion of said consumer data on the network with individual consumers, and
(c) extracting useful consumer advertisement targeting data from said correlated consumer data on the network.
